(19) United States
(12) Patent Application Publication
(10) Pub. No.: US 2022/0164647 A1
(43) Pub. Date: May 26, 2022

(54) ACTION PRUNING BY LOGICAL NEURAL NETWORK

(71) Applicant: INTERNATIONAL BUSINESS MACHINES CORPORATION, Armonk, NY (US)

(72) Inventors: Daiki Kimura, Tokyo (JP); Akifumi Wachi, Tokyo (JP); Subhajit Chaudhury, Kawasaki (JP); Ryosuke Kohita, Tokyo (JP); Asim Munawar, Ichikawa (JP); Michiaki Tatsubori, Oiso (JP)

(21) Appl. No.: 17/102,857

(22) Filed: Nov. 24, 2020

(51) Int. Cl. G06N 3/08; G06N 7/00

(52) U.S. Cl. CPC G06N 3/08; G06N 7/005

(57) ABSTRACT

A method for action pruning in Reinforcement Learning receives a current state of an environment. The method evaluates, using a Logical Neural Network (LNN) structure, a logical inference based on the current state. The method outputs upper and lower bounds on each action from a set of possible actions of an agent in the environment, responsive to an evaluation of the logical inference. The method calculates, for each pair of a possible action of the agent in the environment and the current state, a probability by using the upper and lower bounds. Each of calculated probabilities indicates a respective priority ratio for the each action. The method obtains a policy in Reinforcement Learning for the current state by using the calculated probabilities. The method prunes one or more actions from the set of actions as being in violation of the policy such that the one or more actions are ignored.

### BACKGROUND

The present invention generally relates to artificial learning, and more particularly to action pruning by logical neural network.

A Logical Neural Network (LNN) can be trained using logical functions such as, NOT, AND, OR, and so forth. A LNN has weights, activation functions, backward functions, and gradients. This kind of structure is a state-of-the-art neural network for such kind of training. Logical information will be helpful in reinforcement learning in general, however there is no method for integration.

Action Pruning is a technique for dynamically removing actions from the Markov Decision Process (MDP) to reduce the branching factor of the search space. However, there is no AP method which includes the following items: defining the logical rule as human input for calculating the probabilities for action candidates by an additional network work which is generated from human input; and using these probabilities as weights for Q values and also in the random action.

### SUMMARY

According to aspects of the present invention, a computer-implemented method is provided for action pruning in Reinforcement Learning. The method includes receiving a current state of an environment. The method further includes evaluating, using a Logical Neural Network (LNN) structure, a logical inference based on the current state of an environment. The method also includes outputting upper and lower bounds on each action from a set of possible actions of an agent in the environment, responsive to an evaluation of the logical inference. The method additionally includes calculating, for each pair of a possible action of the agent in the environment and the current state of the environment, a probability by using the upper and lower bounds. Each of calculated probabilities indicates a respective priority ratio for the each action. The method further includes obtaining a policy in Reinforcement Learning for the current state of the environment by using the calculated probabilities. The method also includes pruning one or more actions from the set of actions as being in violation of the policy such that the one or more actions are ignored.

According to other aspects of the present invention, a computer program product is provided for action pruning in reinforcement learning. The computer program product includes a non-transitory computer readable storage medium having program instructions embodied therewith. The program instructions are executable by a computer to cause the computer to perform a method. The method includes receiving a current state of an environment. The method further includes evaluating, using a Logical Neural Network (LNN) structure, a logical inference based on the current state of an environment. The method also includes outputting upper and lower bounds on each action from a set of possible actions of an agent in the environment, responsive to an evaluation of the logical inference. The method additionally includes calculating, for each pair of a possible action of the agent in the environment and the current state of the environment, a probability by using the upper and lower bounds. Each of calculated probabilities indicates a respective priority ratio for the each action. The method further includes obtaining a policy in Reinforcement Learning for the current state of the environment by using the calculated probabilities. The method also includes pruning one or more actions from the set of actions as being in violation of the policy such that the one or more actions are ignored.

According to yet other aspects of the present invention, a computer processing system is provided for safe reinforcement learning. The computer processing system includes a memory device for storing program code. The computer processing system further includes one or more hardware processing units for running the program code to receive a current state of an environment. The one or more hardware processing units further run the program code to evaluate, using a Logical Neural Network (LNN) structure, a logical inference based on the current state of an environment. The one or more hardware processing units also run the program code to output upper and lower bounds on each action from a set of possible actions of an agent in the environment, responsive to an evaluation of the logical inference. The one or more hardware processing units additionally run the program code to calculate, for each pair of a possible action of the agent in the environment and the current state of the environment, a probability by using the upper and lower bounds. Each of calculated probabilities indicates a respective priority ratio for the each action. The one or more hardware processing units further run the program code to obtain a policy in Reinforcement Learning for the current state of the environment by using the calculated probabilities. The one or more hardware processing nits also run the program code to prune one or more actions from the set of actions as being in violation of the policy such that the one or more actions are ignored.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram showing an exemplary computing device, in accordance with an embodiment of the present invention;

FIG. 2 is a block diagram showing an exemplary LNN graph structure to which the present invention can be applied, in accordance with an embodiment of the present invention;

FIG. 3 is a block diagram showing exemplary pseudocode for an upward pass, in accordance with an embodiment of the present invention;

FIG. 4 is a block diagram showing exemplary pseudocode for a downward pass, in accordance with an embodiment of the present invention;

FIG. 5 is a block diagram showing exemplary pseudocode for a recurrent inference procedure, in accordance with an embodiment of the present invention;

FIG. 6 is a block diagram showing an exemplary architecture and corresponding signals, in accordance with an embodiment of the present invention;

FIGS. 7-8 show an exemplary method, in accordance with an embodiment of the present invention;

FIG. 9 is a block diagram showing an illustrative cloud computing environment having one or more cloud computing nodes with which local computing devices used by cloud consumers communicate, in accordance with an embodiment of the present invention; and

FIG. 10 is a block diagram showing a set of functional abstraction layers provided by a cloud computing environment, in accordance with an embodiment of the present invention.

### DETAILED DESCRIPTION

Embodiments of the present invention are directed to action pruning by logical neural network.

One or more embodiments of the present invention define a more complex structure for bad actions than prior art structures.

Also, one or more embodiments of the present invention use a Logical Neural Network (LNN) that can be trained from given trajectories (other logical frameworks cannot be so trained).

Logical Neural Networks (LNN) are a new representation that simultaneously provides key properties of both neural nets (learning) and symbolic logic (reasoning). LNNs can incorporate domain knowledge and support compound first-order-logic formulae. One or more embodiments of the present invention employ LNNs to standardize the knowledge induction, knowledge representation, and reasoning.

In an embodiment, a LNN is implemented as a form of recurrent neural network with a 1-to-1 correspondence to a set of logical formulae in any of various systems of weighted, real-valued logic, in which evaluation performs logical inference. Features that set LNNs aside from other neural networks include (1) neural activation functions constrained to implement the truth functions of the logical operations they represent, i.e. ∧, ∨, ¬, →, and, in FOL, ∀ and ∃, (2) results expressed in terms of bounds on truth values so as to distinguish known, approximately known, unknown, and contradictory states, and (3) bidirectional inference permitting, e.g., x→y to be evaluated as usual in addition to being able to prove y given x or, just as well, ¬ x given ¬ y. The nature of the modeled system of logic depends on the family of activation functions chosen for the network's neurons, which implement the logic's various atoms and operations.

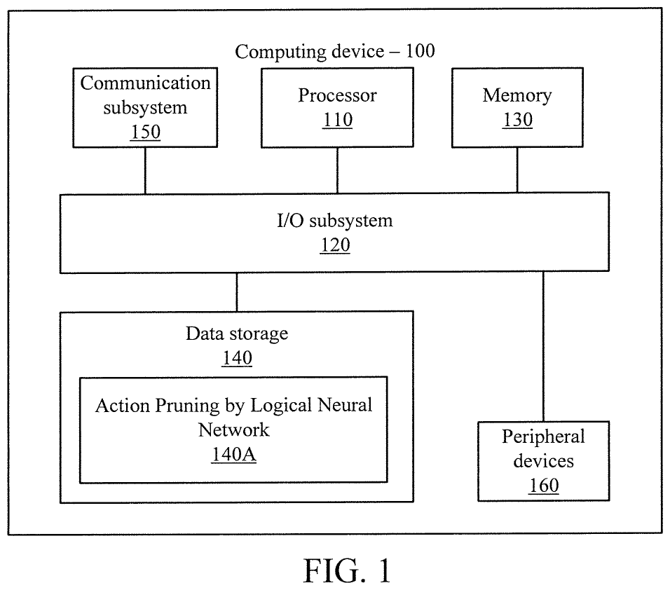

FIG. 1 is a block diagram showing an exemplary computing device 100, in accordance with an embodiment of the present invention. The computing device 100 is configured to perform Action Pruning (AP) by Logical Neural Network (LNN).

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for Action Pruning (AP) by Logical Neural Network (LNN). The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

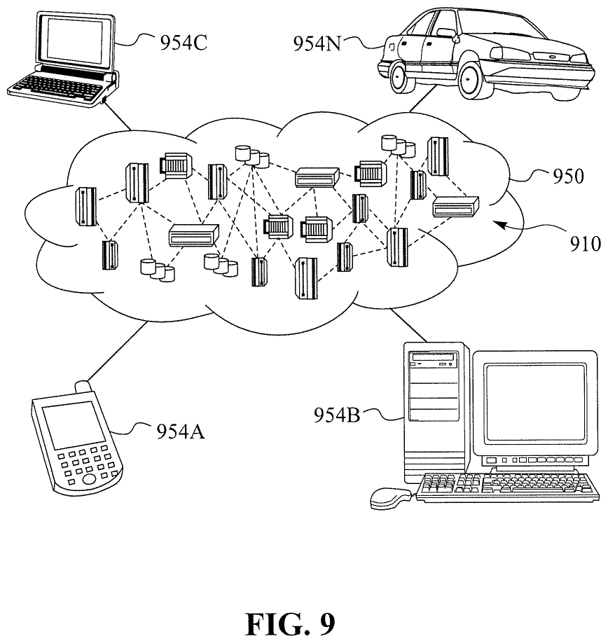

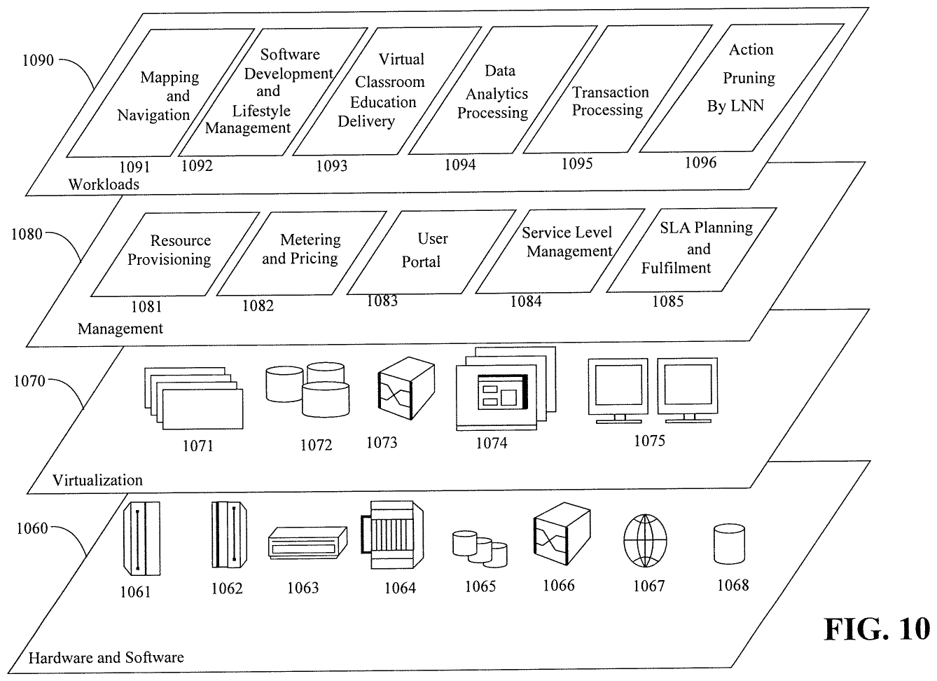

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. Further, in another embodiment, a cloud configuration can be used (e.g., see FIGS. 9-10). These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

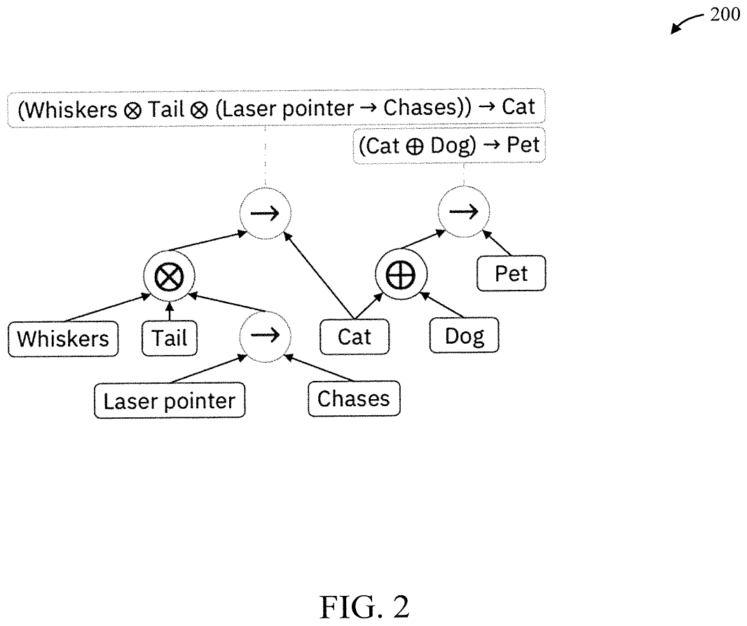

FIG. 2 is a block diagram showing an exemplary LNN graph structure 200 to which the present invention can be applied, in accordance with an embodiment of the present invention.

The LNN graph structure reflects the formulae it represents.

Each of node “Whiskers”, “Tail”, . . . , and “⊕”, “\textcircled{×}”, “→”, in FIG. 2 has an Upper bound value (U) and a Lower bound value (L), normally U>L.

For example, if the Whiskers is TRUE, then the Upper value and Lower values have a high value, such as ˜1.0. If the Whiskers is FALSE, then the Upper value and Lower values have a low value, such as ˜0.0.

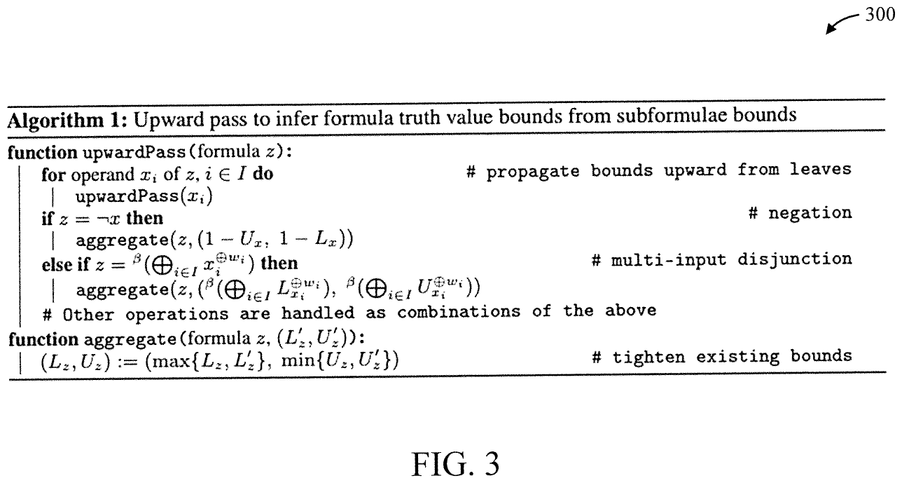

FIG. 3 is a block diagram showing exemplary pseudocode 300 for a first algorithm for an upward pass, in accordance with an embodiment of the present invention.

The pseudocode 300 corresponds to an upward pass to infer formula truth value bounds for subformulae bounds. The pseudocode 300 involves propagating bounds upward from leaves, negation, multi-input disjunction, and tightening of existing bounds.

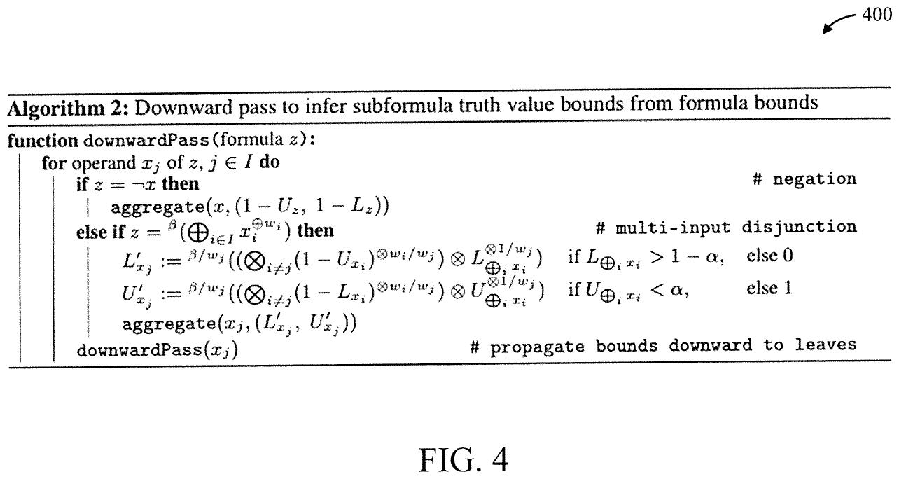

FIG. 4 is a block diagram showing exemplary pseudocode 400 for a second algorithm for a downward pass, in accordance with an embodiment of the present invention.

The pseudocode 400 corresponds to an downward pass to infer formula truth value bounds for subformulae bounds. The pseudocode 400 involves negation, multi-input disjunction, and propagating bounds downward to leaves.

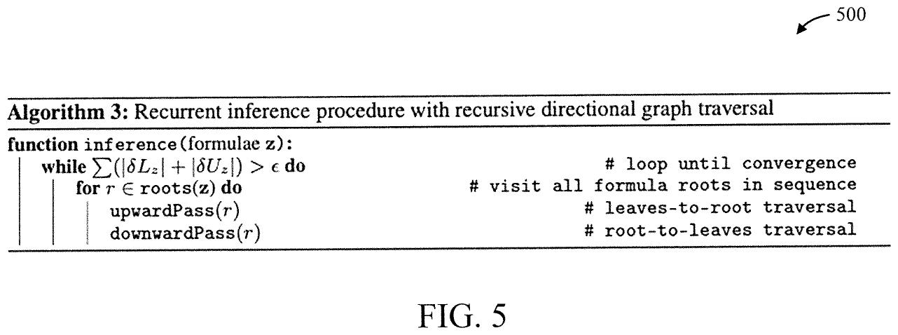

FIG. 5 is a block diagram showing exemplary pseudocode 500 for a third algorithm for a recurrent inference procedure, in accordance with an embodiment of the present invention.

The pseudocode 500 corresponds to a recurrent inference procedure with recursive directional graph traversal. The pseudocode 500 involves looping until convergence, visiting all formulae roots in sequence, a leaves-to-root traversal, and a root-to-leaves traversal.

A description will now be given further regarding the Logical Neural Network (LNN). All neurons return pairs of values in the range 0-1 representing lower and upper bounds on the truth values of their corresponding subformulae and propositions. To aid interpretability of bounds, a threshold of truth ½<α<1 is defined such that a continuous truth value is considered True if it is greater than a, and False if it is less than 1−α. Bound values identify one of four primary states that a neuron can be in, whereas secondary states offer a more-true-than-not or more-false-than-not interpretation.

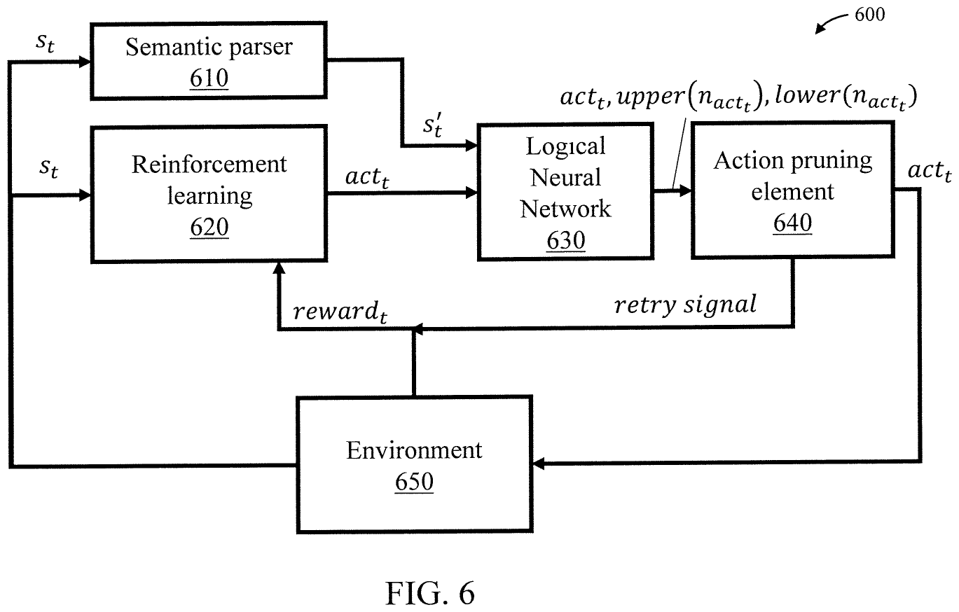

FIG. 6 is a block diagram showing an exemplary architecture 600 and corresponding signals, in accordance with an embodiment of the present invention.

The architecture 600 includes a semantic parser 610, a reinforcement learning element 620, a Logical Neural Network (LNN) 630, a LNN action pruning element 640, and an environment 650.

The semantic parser 610 semantically parses an input agent state.

The reinforcement learning element 620 can be a Long Short Term Memory-Deep Q Network (LTSM-DQN). The reinforcement learning element 620 is for base reinforcement learning method which predicts the action candidate for safe reinforcement learning.

The LNN 630 is for understanding the logical function of safe restriction.

The LNN action pruning element 640 is to avoid useless actions.

The environment 650 is a place in which actions are taken by agents.

The following signal definitions apply:

sₜ denotes an agent state

sₜ′ denotes a semantically modified agent state

actₜ denotes an action at time t

rewardₜ denotes a reward at time t

∀actᵢ ∈ A, actᵢ, upper(n_{act}_{ᵢ}), lower(n_{act}_{ᵢ}) denotes an action having an upper and lower bound

∀actᵢ ∈ A, P_{LNN} (actᵢ|sₜ′ denotes a possibility for action actᵢ and given sₜ′

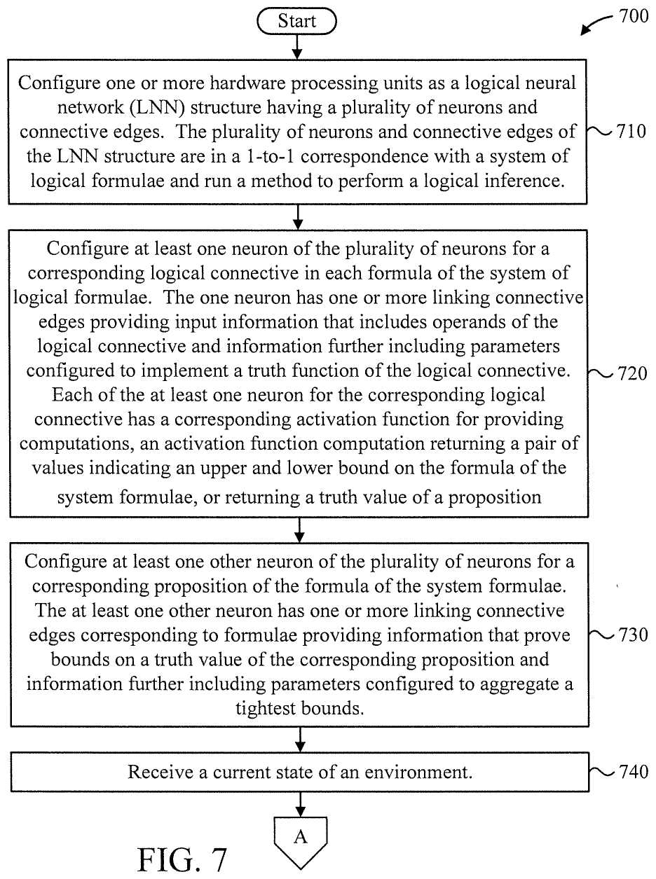

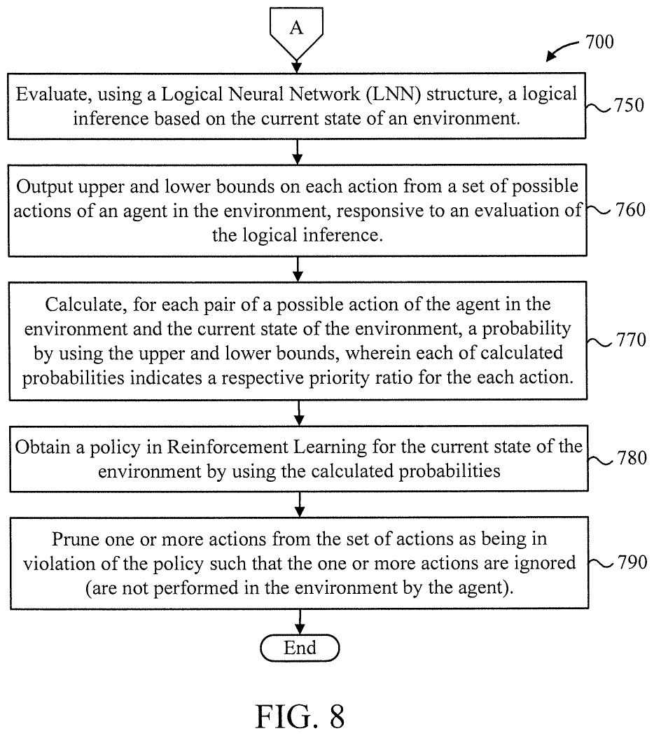

FIGS. 7-8 show an exemplary method 700, in accordance with an embodiment of the present invention.

At block 710, configure one or more hardware processing units as a logical neural network (LNN) structure having a plurality of neurons and connective edges. The plurality of neurons and connective edges of the LNN structure are in a 1-to-1 correspondence with a system of logical formulae and run a method to perform a logical inference.

At block 720, configure at least one neuron of the plurality of neurons for a corresponding logical connective in each formula of the system of logical formulae. The one neuron has one or more linking connective edges providing input information that includes operands of the logical connective and information further including parameters configured to implement a truth function of the logical connective. Each of the at least one neuron for the corresponding logical connective has a corresponding activation function for providing computations, an activation function computation returning a pair of values indicating an upper and lower bound on the formula of the system formulae, or returning a truth value of a proposition. System formulae differ from logical formulae in that the system formulae has logical neurons and activation functions which are not in logical formulae.

At block 730, configure at least one other neuron of the plurality of neurons for a corresponding proposition of the formula of the system formulae. The at least one other neuron has one or more linking connective edges corresponding to formulae providing information that prove bounds on a truth value of the corresponding proposition and information further including parameters configured to aggregate a tightest bounds. The term “to aggregate a tightest bounds” refers to collecting the tightest bounds for a given action.

At block 740, receive a current state of an environment.

At block 750, evaluate, using a Logical Neural Network (LNN) structure, a logical inference based on the current state of an environment.

At block 760, output upper and lower bounds on each action from a set of possible actions of an agent in the environment, responsive to an evaluation of the logical inference.

At block 770, calculate, for each pair of a possible action of the agent in the environment and the current state of the environment, a probability by using the upper and lower bounds, wherein each of calculated probabilities indicates a respective priority ratio for the each action. As used herein, the term “priority ratio” refers to the value for prioritizing to take the targeted action.

At block 780, obtain a policy in Reinforcement Learning for the current state of the environment by using the calculated probabilities.

At block 790, prune one or more actions from the set of actions as being in violation of the policy such that the one or more actions are ignored (are not performed in the environment by the agent).

A description will now be given regarding defining probabilities from the LNN, in accordance with an embodiment of the present invention.

Calculate probabilities for the action αₜ and given state sₜ from the logical neural network (LNN) which is defined by a human or trained from input state-actio pairs

For example, the action probabilities P_{LNN}(αₜ|sₜ) in given sₜ (0≤P_{LNN}(αₜ|sₜ)≤1, P_{LNN}(αₜ|sₜ) represents the priority ratio for each action) will be calculated from following equation,

$$∀ {a}_{t} ∈ A , {P}_{L N N} ( {a}_{t} \vert {s}_{t} ) = \frac{{e}^{v ( {a}_{t} \vert {θ}_{L N N} )}}{{\sum }_{j} {e}^{v ( {a}_{j} \vert {θ}_{LNN} )}} , v ( {a}_{i} \vert {θ}_{LNN} ) = \frac{{upper}_{{a}_{i} \vert {θ}_{LNN}} + {lower}_{{a}_{i} \vert {θ}_{LNN}}}{2} - {contradiction}_{{a}_{i} \vert {θ}_{LNN}} , \\ {contradiction}_{{a}_{i} \vert {θ}_{LNN}} = {\sum }_{{n}_{j}} max ( 0 , lower ( {n}_{i} ) - upper ( {n}_{i} ) )$$

where A is a given action list, and the contradiction value represents the level of contradiction for each logic rule.

Policy will be following ith possibilities P_{LNN}(αₜ|sₜ) in q-alue and exploration. This means the policy will take an action with possibilities, e.g. if the (P_{LNN}(α|sₜ)) is high, the αₜ has high possibility to take during the exploration and q-value-based exploitation.

For example, the policy is to use the deep q-network as follows:

$$π ( {s}_{t} ) = \{ \begin{matrix}{argmax}_{a ∈ A} ( {P}_{LNN} ( a \vert {s}_{t} ) Q ( {s}_{t} , a ) ) \text{:} & ζ \geq ϵ \\ {random}_{a ∈ A} ( {P}_{L N N} ( a \vert {s}_{t} ) ) \text{:} & otherwise\end{matrix}$$

where ∈ is epsilon greedy parameter, and ξ is a current random value.

A description will now be given regarding possible requirement for a LNN used in accordance with the present invention.

Each neuron (which is represented by the proposition) needs to have upper and lower bound value, these are connected to a logical connective operator (AND, OR, IMPLY gate) with an activation function and weight values.

The input layer has some propositions for state input (in this invention, these are the logical states for each environment state input), the hidden layer has the logical operator (these have some weights values), output layer has some propositions for actions.

The output layer is not needed to set the action values from the output of reinforcement learning. The output of the output layer (which is the output of the LNN) is used for selecting an action (not only rejecting, but also recommending).

The propositions for all actions are needed to be set to calculate the action values.

The parameters (that is, weights and bias values) are trainable during the execution.

A further description will now be given regarding action pruning, in accordance with an embodiment of the present invention.

Let Ø(sₜ), lowerₙ_{ᵢ}_{,s}_{_{t′}}, upperₙ_{ᵢ}_{,s}_{_{t′}}ctrd(αₜ, sₜ) be the same as the definitions in the LNNs-Shielding method. The LNNs-Guide provides probabilities for recommendation of the action for each state input. The probability is calculated by the following:

$$\begin{matrix}PLNN ( a \vert {s}_{t} ) = \frac{{e}^{ν ( a , {s}_{t} )}}{{Σ}_{{a}_{j} ∈ A} {e}^{v ( {a}_{j} , {s}_{t} )}} & ( 1 ) \\ ν ( a , {s}_{t} ) = \frac{lowe {r}_{a , {s}_{t}} + {upper}_{a} , {s}_{t}}{2} - ctrd ( a , {s}_{t} ) & ( 2 )\end{matrix}$$

where a is a targeted action for calculating the probability, and A is all actions. Value v(a; sₜ) represents the level of truth values for the propositions while discounting the contradiction value.

In reinforcement learning, the policy follows the probabilities calculated with the epsilon greedy algorithm in LSTMDQN++. In accordance with one or more embodiments of the present invention, the action αₜ is selected by the following:

$${a}_{t} = \{ \begin{matrix}{arg max}_{a ∈ A} P L N N ( a \vert {s}_{t} ) Q ( {s}_{t} , a ) : & ζ \geq ϵ \\ {arg max}_{a ∈ A} P L N N ( a \vert {s}_{t} ) : & otherwise\end{matrix} \qquad ( 3 )$$

where ζ is the current random value for epsilon greedy, and random_{α∈A}_{^{P}} takes an action in accordance with probabilities P. In this equation, an action is selected on the basis of q-value and action probabilities from LNNs-Guide. Training steps by the reward signal are performed in the same way as in the reinforcement learning method.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 9, illustrative cloud computing environment 950 is depicted. As shown, cloud computing environment 950 includes one or more cloud computing nodes 910 with which local computing devices used by cloud consumers, such as, for example, personal digital assistant (PDA) or cellular telephone 954A, desktop computer 954B, laptop computer 954C, and/or automobile computer system 954N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that computing nodes 910 and cloud computing environment 950 can communicate with any type of computerized device over any type of network and/or network addressable connection (e.g., using a web browser).

Referring now to FIG. 10, a set of functional abstraction layers provided by cloud computing environment 950 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Examples of workloads and functions which may be provided from this layer include: mapping and navigation 1091; software development and lifecycle management 1092; virtual classroom education delivery 1093; data analytics processing 1094; transaction processing 1095; and safe reinforcement learning by LNN 1096.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for action pruning in Reinforcement Learning comprising:
receiving a current state of an environment;
evaluating, using a Logical Neural Network (LNN) structure, a logical inference based on the current state of an environment;
outputting upper and lower bounds on each action from a set of possible actions of an agent in the environment, responsive to an evaluation of the logical inference;
calculating, for each pair of a possible action of the agent in the environment and the current state of the environment, a probability by using the upper and lower bounds, wherein each of calculated probabilities indicates a respective priority ratio for the each action;
obtaining a policy in Reinforcement Learning for the current state of the environment by using the calculated probabilities; and
pruning one or more actions from the set of actions as being in violation of the policy such that the one or more actions are ignored.

2. The computer-implemented method of claim 1, wherein the each pair of the possible action of the agent in the environment and the current state of the environment are defined by a human.

3. The computer-implemented method of claim 1, wherein the each pair of the possible action of the agent in the environment and the current state of the environment are trained from input state-action pairs.

4. The computer-implemented method of claim 1, wherein the probability is calculated by using the upper and lower bounds further by using logic rule contradiction values, each of the logic rule contradiction values representing a level of contradiction for each of a plurality of logic rules associated with the LNN.

5. The computer-implemented method of claim 4, wherein a contradiction comprises having a higher lower bound value than an upper bound value.

6. The computer-implemented method of claim 1, performing an exploration in the environment responsive to the policy.

7. The computer processing system of claim 1, further comprising aiding a bound interpretability using a threshold of truth ½<α<1, such that a continuous truth value is considered True if the continuous truth value is greater than a, and False if the continuous truth value is less than 1−α.

8. The computer-implemented method of claim 1, further comprising configuring the one or more hardware processing units as the LNN structure having a plurality of neurons and connective edges, the plurality of neurons and connective edges of the LNN structure in a 1-to-1 correspondence with a system of logical formulae and running a method to perform the action safetyness logical inference,
wherein at least one neuron of the plurality of neurons relates to a corresponding logical connective in each formula of the system of logical formulae, the at least one neuron having one or more linking connective edges providing input information comprising operands of the corresponding logical connective and information further comprising parameters configured to implement a truth function of the corresponding logical connective, wherein each of the at least one neuron has a corresponding activation function for providing computations, and wherein an activation function computation returns a pair of values indicating an upper and lower bound on a formula of system formulae, or returns a truth value of a proposition of the formula of the system formulae.

9. The computer-implemented method of claim 8, wherein at least one other neuron of the plurality of neurons relates to the proposition, the at least one other neuron having one or more linking connective edges corresponding to formulae providing information that prove upper and lower bounds on a truth value of the corresponding proposition and information further comprising parameters configured to aggregate a tightest bounds.

10. A computer program product for action pruning in reinforcement learning, the computer program product comprising a non-transitory computer readable storage medium having program instructions embodied therewith, the program instructions executable by a computer to cause the computer to perform a method comprising:
receiving a current state of an environment;
evaluating, using a Logical Neural Network (LNN) structure, a logical inference based on the current state of an environment;
outputting upper and lower bounds on each action from a set of possible actions of an agent in the environment, responsive to an evaluation of the logical inference;
calculating, for each pair of a possible action of the agent in the environment and the current state of the environment, a probability by using the upper and lower bounds, wherein each of calculated probabilities indicates a respective priority ratio for the each action;
obtaining a policy in Reinforcement Learning for the current state of the environment by using the calculated probabilities; and
pruning one or more actions from the set of actions as being in violation of the policy such that the one or more actions are ignored.

11. The computer program product of claim 10, wherein the each pair of the possible action of the agent in the environment and the current state of the environment are defined by a human.

12. The computer program product of claim 10, wherein the each pair of the possible action of the agent in the environment and the current state of the environment are trained from input state-action pairs.

13. The computer program product of claim 10, wherein the probability is calculated by using the upper and lower bounds further by using logic rule contradiction values, each of the logic rule contradiction values representing a level of contradiction for each of a plurality of logic rules associated with the LNN.

14. The computer program product of claim 13, wherein a contradiction comprises having a higher lower bound value than an upper bound value.

15. The computer program product of claim 10, performing an exploration in the environment responsive to the policy.

16. The computer program product of claim 10, further comprising aiding a bound interpretability using a threshold of truth ½<α<1, such that a continuous truth value is considered True if the continuous truth value is greater than a, and False if the continuous truth value is less than 1−α.

17. The computer program product of claim 10, further comprising configuring the one or more hardware processing units as the LNN structure having a plurality of neurons and connective edges, the plurality of neurons and connective edges of the LNN structure in a 1-to-1 correspondence with a system of logical formulae and running a method to perform the action safetyness logical inference,
wherein at least one neuron of the plurality of neurons relates to a corresponding logical connective in each formula of the system of logical formulae, the at least one neuron having one or more linking connective edges providing input information comprising operands of the corresponding logical connective and information further comprising parameters configured to implement a truth function of the corresponding logical connective, wherein each of the at least one neuron has a corresponding activation function for providing computations, and wherein an activation function computation returns a pair of values indicating an upper and lower bound on a formula of system formulae, or returns a truth value of a proposition of the formula of the system formulae.

18. A computer processing system for safe reinforcement learning comprising:
a memory device for storing program code;
one or more hardware processing units for running the program code to receive a current state of an environment;
evaluate, using a Logical Neural Network (LNN) structure, a logical inference based on the current state of an environment;
output upper and lower bounds on each action from a set of possible actions of an agent in the environment, responsive to an evaluation of the logical inference;
calculate, for each pair of a possible action of the agent in the environment and the current state of the environment, a probability by using the upper and lower bounds, wherein each of calculated probabilities indicates a respective priority ratio for the each action;
obtain a policy in Reinforcement Learning for the current state of the environment by using the calculated probabilities; and
prune one or more actions from the set of actions as being in violation of the policy such that the one or more actions are ignored.

19. The computer processing system of claim 18, wherein the each pair of the possible action of the agent in the environment and the current state of the environment are defined by a human.

20. The computer processing system of claim 18, wherein the each pair of the possible action of the agent in the environment and the current state of the environment are trained from input state-action pairs.
